(19) United States
(12) Patent Application Publication
(10) Pub. No.: US 2022/0047043 A1
(43) Pub. Date: Feb. 17, 2022

(54) INCREASED WEAR RESISTANCE FOR SNOWBOARDING BOOTS

(71) Applicant: Adam Gazzola, Medford, MA (US)

(72) Inventor: Adam Gazzola, Medford, MA (US)

(21) Appl. No.: 17/393,688

(22) Filed: Aug. 4, 2021

Related U.S. Application Data
(60) Provisional application No. 63/064,076, filed on Aug. 11, 2020.

(51) Int. Cl. A43C 13/08; B32B 7/12; B32B 7/06

(52) U.S. Cl. CPC A43C 13/08; B32B 7/12; B32B 2451/00; B32B 2307/581; B32B 7/06

(57) ABSTRACT

Various approaches for providing cut-resistant material to a snowboarding boot are provided herein. An example cut-resistant patch for application onto a snowboarding boot includes a first layer of cut-resistant material and a second layer of adhesive material positioned below the first layer of cut-resistant material. The adhesive material is configured to adhere to the snowboarding boot so as to present the cut-resistant material outwardly from the snowboarding boot. The cut-resistant material is configured to protect the snowboarding boot from wear or cuts caused by a snowboard being positioned thereon.

### CROSS-REFERENCE TO RELATED APPLICATION

This application claims the benefit of U.S. Provisional Patent Application Ser. No. 63/064,076, filed Aug. 11, 2020 and titled “INCREASED WEAR RESISTANCE FOR SNOWBOARDING BOOTS”, which is incorporated herein by reference in its entirety.

### FIELD OF THE INVENTION

Embodiments of the present invention relate generally to snowboarding boots and, more particularly, for providing cut-resistance for snowboarding boots to prevent wear caused on exterior surfaces of the snowboarding boots.

### BACKGROUND OF THE INVENTION

Snowboarding boots are frequently used and can cost up to $400 or more per pair. Unlike snow skiing boots, which are frequently formed of a hard-plastic shell at the exterior surface, snowboarding boots are frequently formed of softer material at the external surface. This material on snowboarding boots often wears quickly at certain areas such as a front portion of the snowboarding boot. For example, the front portion of a snowboarding boot regularly comes into contact with a snowboard (e.g., the edges of a snowboard). This contact frequently occurs while a user is on a lift between runs, with the user resting the snowboard on the front portion of their snowboarding boot that is out of the boot binding of the snowboard (where the other snowboarding boot of the pair is still strapped into its respective boot binding). As a result of this contact, a friction force will act on the front portion of the unstrapped snowboarding boot, causing wear at the exterior surface of the unstrapped snowboarding boot. Other forces or conditions also cause wear at the exterior surface of the snowboarding boot. For example, wear may be caused by the ice terrain and icy conditions, by contact made during lift chair operations, by contact made during the use of snowboarding boots during runs, etc. After repetitive contact, the wear often becomes so pronounced that the snowboarding boots become practicably unusable. This results in users being required to frequently purchase replacement snowboarding boots.

### BRIEF SUMMARY OF THE INVENTION

Additional cut-resistance is provided for snowboarding boots to prevent wear caused on exterior surfaces of the snowboarding boots. Additional cut-resistance may be provided in the form of a patch or a covering comprising cut-resistant material, and the shape of the patch or the covering may vary to cover a desired area. A patch may comprise a layer of cut-resistant material and a layer of adhesive material. Cut-resistance may also be provided by integrating cut-resistant material into the fabric of the snowboarding boot during fabrication of the snowboarding boot. Cut-resistance may be provided at the front portion of the snowboarding boot that surrounds a bridge of a foot contained therein and/or at areas on a snowboarding boot that are susceptible to repetitive wear.

In an example embodiment, a cut-resistant patch for application onto a snowboarding boot is presented. The patch comprises a first layer of cut-resistant material and a second layer of adhesive material positioned below the first layer of cut-resistant material. The adhesive material is configured to adhere to the snowboarding boot so as to present the cut-resistant material outwardly from the snowboarding boot. The cut-resistant material is configured to protect the snowboarding boot from wear or cuts caused by a snowboard being positioned thereon.

In some embodiments, the first layer may have a top face and a bottom face, and the second layer may have a top face and a bottom face. The top face of the second layer may be adjacent to the bottom face of the first layer. In some related embodiments, the top face of the second layer may be affixed to the bottom face of the first layer.

In some embodiments, the cut-resistant patch further may comprise a removable third layer positioned below the second layer of adhesive material. Removal of the third layer may reveal access to the second layer of adhesive material to enable adhering of the patch to the snowboarding boot. In some embodiments, the second layer of adhesive may be configured to be removable from the snowboarding boot by a user.

In some embodiments, the first layer of cut-resistant material may comprise at least one of a rubber composite, Kevlar, or nylon. The second layer of adhesive material may, in some embodiments, be comprised of at least one of a permanent fabric glue, liquid silicone adhesive, a polyurea adhesive, or a water-based adhesive.

In some embodiments, each of the first layer and the second layer may be configured to be flexible so that the patch can adapt to various shapes of snowboarding boots.

In some embodiments, an initial size of the patch may be such that covers a front portion of the snowboarding boot, and the front portion of the snowboarding boot may surround a bridge of a foot contained therein. In some related embodiments, both the first layer and the second layer may be customizable in size and shape via cutting from a pair of scissors. In this way, a user may cause the patch to form at least one of a desired shape or size.

In some embodiments, the first layer of cut-resistant material may further include a printed image, and this printed image may be presented outwardly from the snowboarding boot.

In another embodiment, a system comprising a snowboarding boot and a cut-resistant patch for protecting the snowboarding boot is presented. The patch comprises a first layer of cut-resistant material and a second layer of adhesive material positioned below the first layer of cut-resistant material. The adhesive material is configured to adhere to the snowboarding boot so as to present the cut-resistant material outwardly from the snowboarding boot. The cut-resistant material is configured to protect the snowboarding boot from wear or cuts caused by a snowboard being positioned thereon.

In some embodiments, the first layer may have a top face and a bottom face, and the second layer may have a top face and a bottom face. The top face of the second layer may be adjacent to the bottom face of the first layer. The top face of the second layer may be affixed to the bottom face of the first layer.

In some embodiments, a removable third layer may be positioned below the second layer of adhesive material. Removal of the third layer may reveal access to the second layer of adhesive material to enable adhering of the patch to the snowboarding boot.

In some embodiments, an initial size of the patch may be such that it covers a front portion of the snowboarding boot. The front portion of the snowboarding boot may surround a bridge of a foot contained therein. Additionally, both the first layer and the second layer may be customizable in size and shape via cutting from a pair of scissors such that a user may cause the patch to form at least one of a desired shape or size.

In another embodiment, a cut-resistant covering for use with a snowboarding boot is presented. The covering defines a shape adapted to be fit over a front portion of the snowboarding boot that surrounds a bridge of a foot contained therein. The covering comprises at least a layer of cut-resistant material positioned along the shape such that the cut-resistant material is presented outwardly from the snowboarding boot when the covering is fit over the front portion of the snowboarding boot. The cut-resistant material is configured to protect the snowboarding boot from wear or cuts caused by a snowboard being positioned thereon.

In some embodiments, the cut-resistant covering of claim may further comprise a strap adapted to extend around a back portion of the snowboarding boot that surrounds a heel of the foot contained therein. In some embodiments, the shape may define a tubular shape that is adapted to be fit over the front portion of the snowboarding boot and may surround the front portion.

In some embodiments, the shape may define a first portion and a second portion. The first portion may have a tubular shape, and the second portion may form a rounded cap at one end of the first portion. The first portion and the second portion may be adapted to be fit over the front portion of the snowboarding boot and surround the front portion.

In another embodiment, cut-resistance is provided by integrating cut-resistant material into an external surface of a snowboarding boot. This cut-resistant material may be provided on only one snowboarding boot, but the cut-resistant material may also be implemented into both snowboarding boots. Cut-resistance may also be provided over the entire external surface of the snowboarding boot. Alternatively, cut-resistance may be provided at specific locations of the snowboarding boot. For example, cut-resistance may be provided at the front portion of a snowboarding boot.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention.

### BRIEF DESCRIPTION OF THE DRAWINGS

Having thus described the invention in general terms, reference will now be made to the accompanying drawings, which are not necessarily drawn to scale, and wherein:

FIG. 1 illustrates a front view of an example snowboarding boot.

FIG. 2 illustrates a side view of an example snowboarding boot that is in contact with a snowboard.

FIG. 3 illustrates an example snowboarding boot that has been damaged at its front portion.

FIG. 4 illustrates a top view of an example patch, in accordance with some embodiments discussed herein.

FIG. 5A illustrates a cross-sectional schematic view of various layers of an example patch, in accordance with some embodiments discussed herein.

FIG. 5B illustrates an exploded view of the layers shown in FIG. 5A, in accordance with some embodiments discussed herein.

FIG. 6 illustrates an example snowboarding boot with an example patch positioned on a front portion of the example snowboarding boot, in accordance with some embodiments discussed herein.

FIG. 7 illustrates an example snowboarding boot with two example patches fit onto the example snowboarding boot, in accordance with some embodiments discussed herein.

FIG. 8 illustrates a side view of an example snowboarding boot and an example snowboard, wherein one of the example patches from FIG. 7 is positioned on the example snowboarding boot such that it is in contact with the snowboard, in accordance with some embodiments discussed herein.

FIG. 9 illustrates the example snowboarding boot with the example patch shown in FIG. 8 strapped into the binding of the example snowboard, in accordance with some embodiments discussed herein.

FIG. 10 illustrates a schematic view of an example snowboarding boot with an example covering that uses straps, in accordance with some embodiments discussed herein.

FIG. 11 illustrates a schematic view of an example snowboarding boot with an example tubular covering, in accordance with some embodiments discussed herein.

FIG. 12A illustrates a schematic view of an example snowboarding boot with an example rounded covering, in accordance with some embodiments discussed herein.

FIG. 12B illustrates a schematic view of an example snowboarding boot with another example rounded covering, in accordance with some embodiments discussed herein.

### DETAILED DESCRIPTION

Exemplary embodiments of the present invention now will be described more fully hereinafter with reference to the accompanying drawings, in which some, but not all embodiments of the invention are shown. Indeed, the invention may be embodied in many different forms and should not be construed as limited to the exemplary embodiments set forth herein; rather, these embodiments are provided so that this disclosure will satisfy applicable legal requirements. Like reference numerals refer to like elements throughout.

Example embodiments described herein help to address the issues described above, such as by providing increased resistance against wear for a snowboarding boot. As described below, a patch or a covering may be used to cover the external surface of a snowboarding boot. This patch or covering may be positioned at critical areas where a snowboarding boot may become worn, such as at a front portion of the snowboarding boot. Patches or coverings may comprise a cut-resistant material such as Kevlar, nylon, fiberglass, polyethylene fiber, or steel. When a patch or a covering is secured to a snowboarding boot, any friction from a snowboard or from some other object will act on the patch or covering rather than the external surface of the snowboarding boot, so the risk of accelerated wear may be prevented. The patch or covering is more resistant to wear due to the cut-resistant material, so the lifespan of patch or covering may be increased. Some embodiments may be quickly applied to the snowboarding boot or removed from the snowboarding boot. However, users may optionally secure patches or coverings on the snowboarding boot permanently.

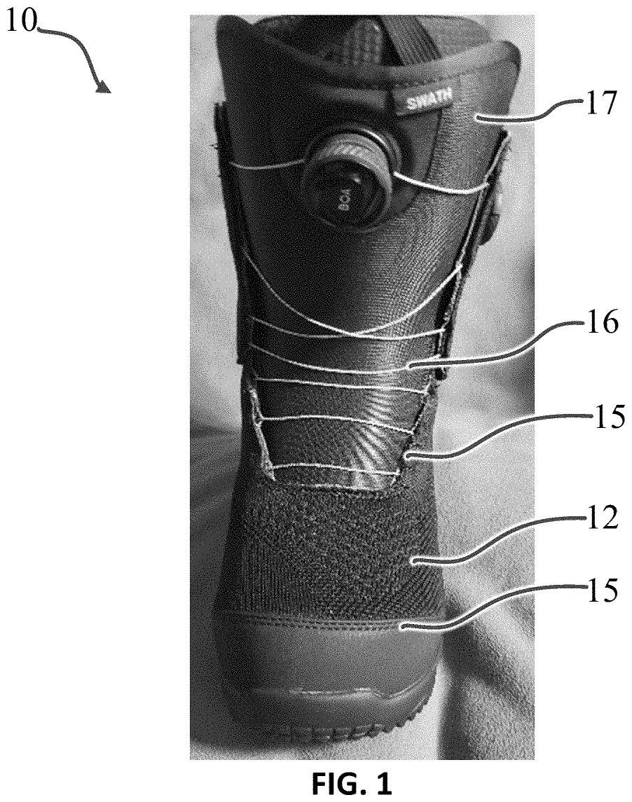

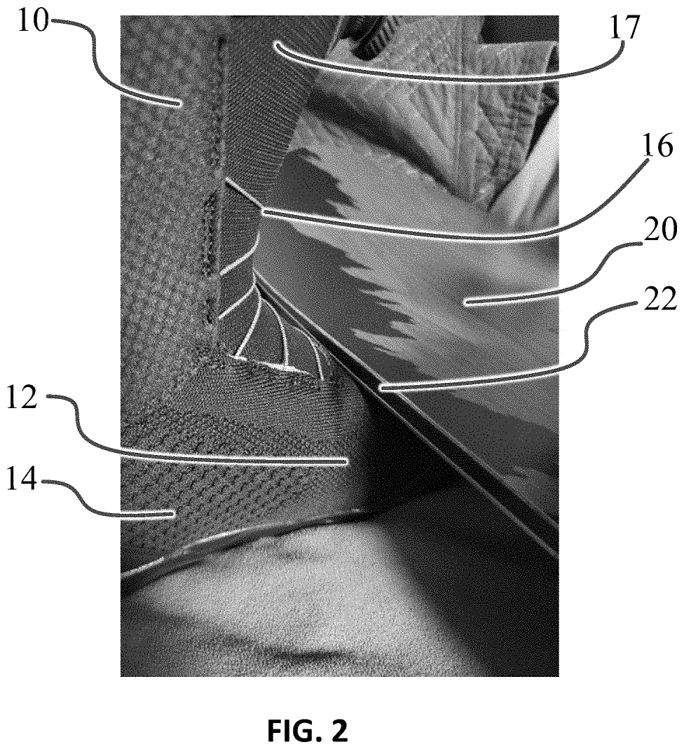

FIG. 1 illustrates an example snowboarding boot 10. As depicted in FIGS. 1 and 2, this snowboarding boot 10 comprises a front portion 12, a back portion 14, laces 16 (although straps or other attachment features may be used), and a tongue 17. The front portion 12 may be the portion of the snowboarding boot 10 surrounding a bridge of a foot contained therein. The back portion 14 may be the portion of the snowboarding boot 10 surrounding a heel of a foot contained therein. A front portion 12, depending on the style of the boot, may also include stitching 15.

FIG. 2 illustrates a side view of a snowboarding boot 10 that is in contact with a snowboard 20. The snowboard 20 comprises an edge 22, and in some snowboards, this edge 22 may be thin and/or sharp. As depicted in FIG. 2, the snowboard 20 may rest on the front portion 12 of the snowboarding boot 10, and the snowboard 20 may frequently rest on the front portion 12 in this manner while a user is on a lift between runs. A user may often unstrap one snowboarding boot 10 from the boot binding 24 of the snowboard 20 while leaving the other snowboarding boot 10 strapped into its boot binding 24 of the snowboard 20. A user may do this, for example, when the user is on a lift between runs. After unstrapping one of the snowboarding boots 10, the user may rest the snowboard 20 on the front portion 12 of their unstrapped snowboarding boot 10. As a result of this contact, a friction force may act on the front portion 12 of the unstrapped snowboarding boot 10, causing wear at the exterior surface of the unstrapped snowboarding boot 10. After repetitive contact, the wear often becomes so pronounced that one or both of the snowboarding boots 10 become practicably unusable. Additionally, a user often unstraps the same snowboarding boot 10 each time, leaving that snowboarding boot 10 susceptible to more accelerated wear.

As a result of the repetitive friction between the snowboard 20 and the front portion 12 of the snowboarding boot 10, the front portion 12 of the snowboarding boot 10 may wear more quickly. Further, in some cases, contact between the edge 22 of the snowboard 20 and the front portion 12 of the snowboarding boot 10 can result in even more pronounced wear on the front portion 12, especially when snowboards with sharper edges are used. This edge 22 may cause a cutting action on the exterior material of the snowboarding boot 10 near the front portion 12, causing an accelerated deterioration of the exterior material. The snowboard 22 may also cause an increased amount of wear at areas such as the stitching 15 and the laces 16.

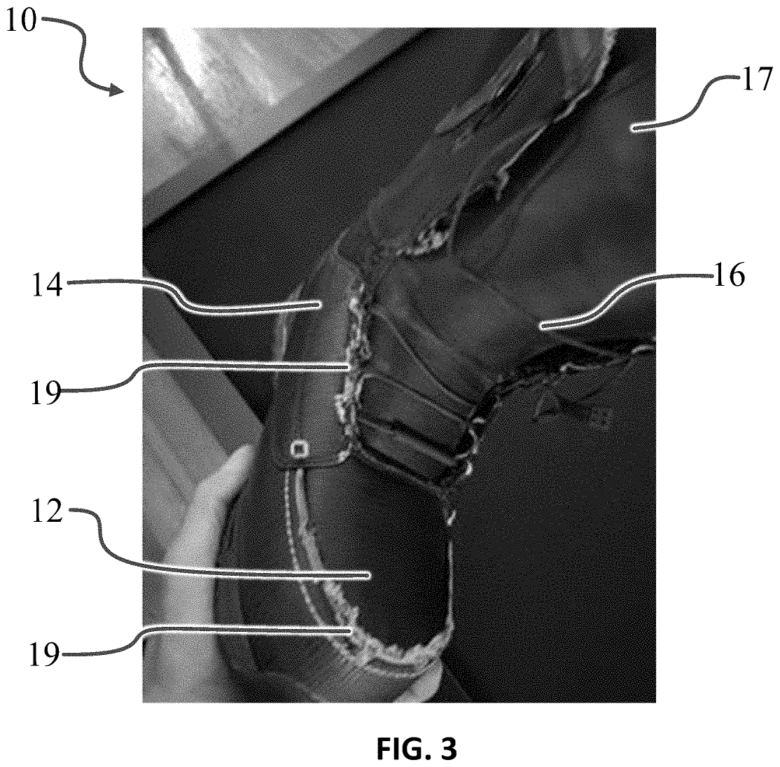

FIG. 3 illustrates a snowboarding boot 10 that has been damaged (shown, for example, as 19) at its front portion 12. As depicted in FIG. 3, the exterior material of the snowboarding boot 10 has been worn at the front portion 12. Damage is most pronounced at the stitching 15 (see FIG. 1) near the front portion 12 and at the laces 16. However, damage may be caused at other areas on front portion 12. This wear may occur as a result of repetitive contact by a snowboard 20 (such as the edge 22 of the snowboard 20).

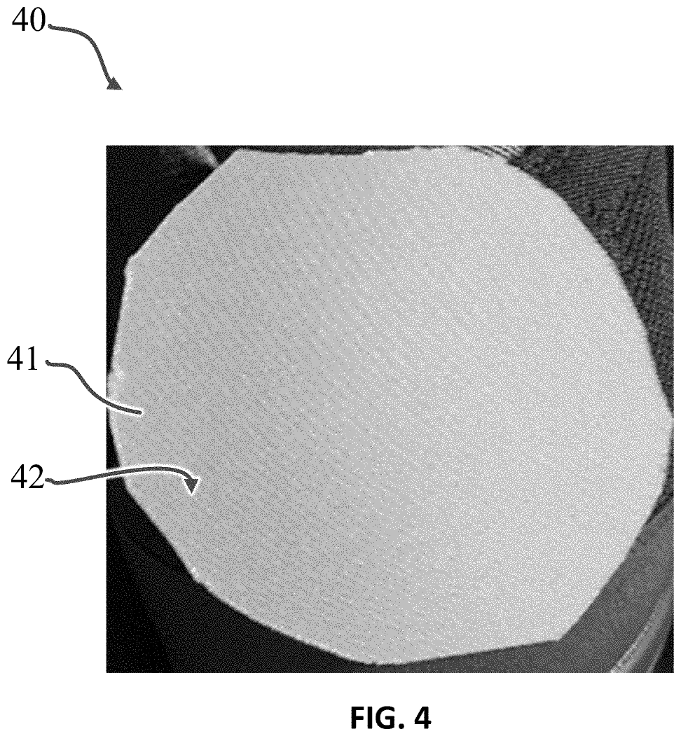

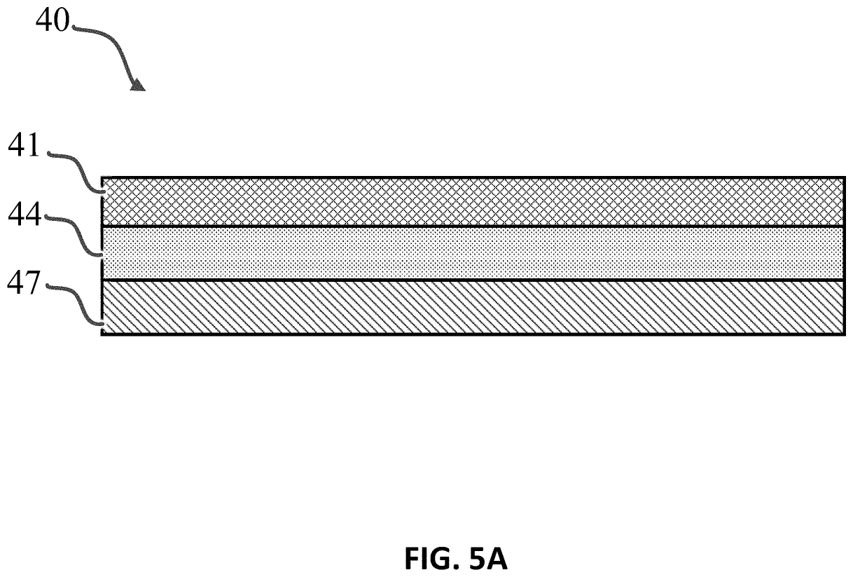

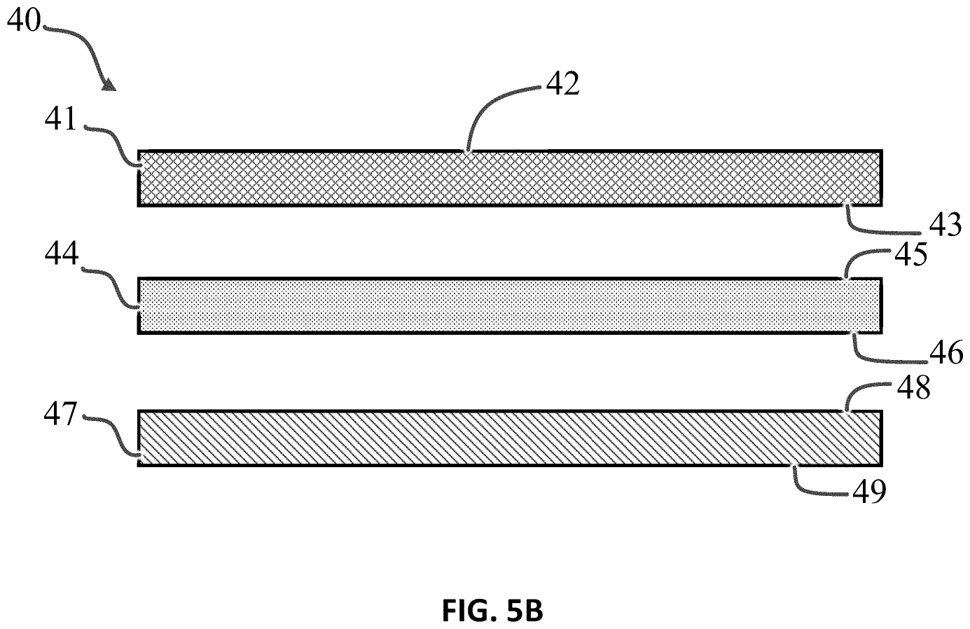

FIG. 4 illustrates a top view of an example patch 40 that can be fit to the snowboarding boot 10 to prevent or limit wear of the snowboarding boot 10, such as in accordance with some embodiments discussed herein. The patch 40 may comprise a cut-resistant material, and this cut-resistant material may form a first layer 41 that is presented outwardly from the snowboarding boot. The first layer 41 may be configured to protect the snowboarding boot 10 from wear or cuts caused by a snowboard 20 being positioned on the snowboarding boot 10. The first layer 41 may comprise a top face 42 and a bottom face 43 (shown in FIGS. 5A-5B).

The patch shown in FIG. 4 comprises a generally circular shape, but a variety of shapes may be used. The patch may define a size that covers the front portion 12 (see FIG. 1) of the snowboarding boot 10 (see FIG. 1). In some embodiments, the patch 40 and each of the layers within the patch may be customizable in size and shape via cutting from a pair of scissors such that a user may cause the patch to form a desired shape or size. For example, the initial size of the patch 40 may be large, and the user may cut out a portion of the patch to form a desired shape such as the shape shown in FIG. 4 using a pair of scissors or some other cutting device.

FIGS. 5A and 5B illustrate schematic views of various layers of a patch in accordance with some embodiments discussed herein. FIG. 5A shows the various layers stacked on top of each other as they would typically be positioned in some embodiments. FIG. 5B shows these various layers positioned apart from each other (in an exploded view) for the purposes of explanation. The patch 40 may comprise a first layer 41, a second layer 44, and a third layer 47. The first layer 41 may comprise a top face 42 and a bottom face 43. The second layer 44 may comprise a top face 45 and a bottom face 46. The third layer 47 may comprise a top face 48 and a bottom face 49. Notably, the thicknesses of each of the first layer 41, the second layer 44, and the third layer 47 may vary (such with respect to the other layers).

After application of the patch 40 to the snowboarding boot, the top face 42 of the first layer 41 may be presented outwardly from a snowboarding boot. The second layer 44 may be positioned below the first layer 41 so that the bottom face 43 of the first layer 41 contacts the top face 45 of the second layer 44. The bottom face 43 of the first layer 41 may be affixed to the top face 45 of the second layer 44, and this may be accomplished in a variety of ways. For example, adhesive material within the second layer 44 may form an adhesive bond with the material that forms the first layer 41. Alternatively, a light mesh material may surround the adhesive material at the second layer 44, the mesh material may define a large number of openings so that the adhesive material may remain exposed, and the mesh material may be secured to the first layer 41 by stitching or in another similar manner. In an embodiment, the second layer 44 is configured to be removable from the snowboarding boot by a user. The third layer 47 may be positioned below the second layer 44 so that the bottom face 46 of the second layer 44 contacts the top face 48 of the third layer 47.

While the first layer 41, the second layer 44, and the third layer 47 each lie flat in FIGS. 5A and 5B, each of these layers may be configured to be flexible so that the patch 40 can adapt to various shapes of snowboarding boots and still provide the desired protection. For example, where a patch 40 is applied to a snowboarding boot 10 at a rounded surface of the snowboarding boot 10 (see FIG. 1), the first layer 41, the second layer 44, and the third layer 47 may each be flexible to allow the layers to adapt to this rounded shape so that each of these layers form a rounded shape as well.

As discussed above in reference to FIG. 4, the first layer 41 may be formed by a cut-resistant material. For example, the first layer 41 may be formed of rubber composites, Kevlar, nylon, fiberglass, polyethylene fiber, steel or other cut-resistant material, or various combinations thereof. In some embodiments, a blend of these materials or other materials may be used to form the first layer 41 so that the first layer 41 may be cut-resistant.

The second layer 44 may comprise an adhesive material. In some embodiments, the adhesive material may be formed of permanent fabric glues, fabric adhesives such as a liquid silicone adhesive, a polyurea adhesive, a water-based non-toxic urethane adhesive, and other water-based adhesives, among others. However, other types of adhesive materials may also be used. In some embodiments, one or more adhesive materials may be blended together, and some non-adhesive material may also be included.

In some embodiments, such as shown in FIGS. 5A and 5B, a third layer 47 may be included. The third layer 47 may be removable from the adhesive material in the second layer 44. This third layer 47 may protect the adhesive material in the second layer 44 until the adhesive material is ready to be positioned on a snowboarding boot, allowing the adhesive nature of the second layer 44 to be maintained. The third layer 47 may be a thin layer of paper or some other material. A material may be selected for the third layer 47 so that the third layer will form only a light adhesive bond with the second layer 44. Such a light adhesive bond will allow the third layer 47 to remain secured to the adhesive second layer 44 until a user wishes to remove the third layer 47, and the light adhesive bond may also allow the third layer 47 to be removed by a user without exerting an excessive amount of force. The third layer 47 may be removed so that access to the bottom face 46 of the second layer 44 may be revealed. The exposed bottom face 46 of the second layer 44 may then be placed in the desired position on the exterior surface of the snowboarding boot 10 (see FIG. 1).

In some embodiments, a material may be selected for the second layer 44 so that the second layer 44 may form a stronger adhesive bond with the first layer 41 and with the exterior surface of a snowboarding boot 10 (see FIG. 1) while forming a weaker adhesive bond with the third layer 47. In this way, the third layer 47 may be removed from the second layer 44 without requiring a user to exert much force, and the second layer 44 may still form a strong bond with the first layer 41 and the snowboarding boot 10 (see FIG. 1) so that the patch 40 remains secured to the snowboarding boot 10.

In some embodiments, the top face 42 may comprise a printed image that is presented outwardly from the snowboarding boot 10 (see FIG. 1). For example, the printed image may comprise a patterned image, it may comprise a logo, or the printed image may comprise artwork. The content of the printed image may vary. In some embodiments, the patch may be configured to enable a user to write or draw on the top face 42. In some embodiments, the patch may be configured to enable a user to print on the top face 42.

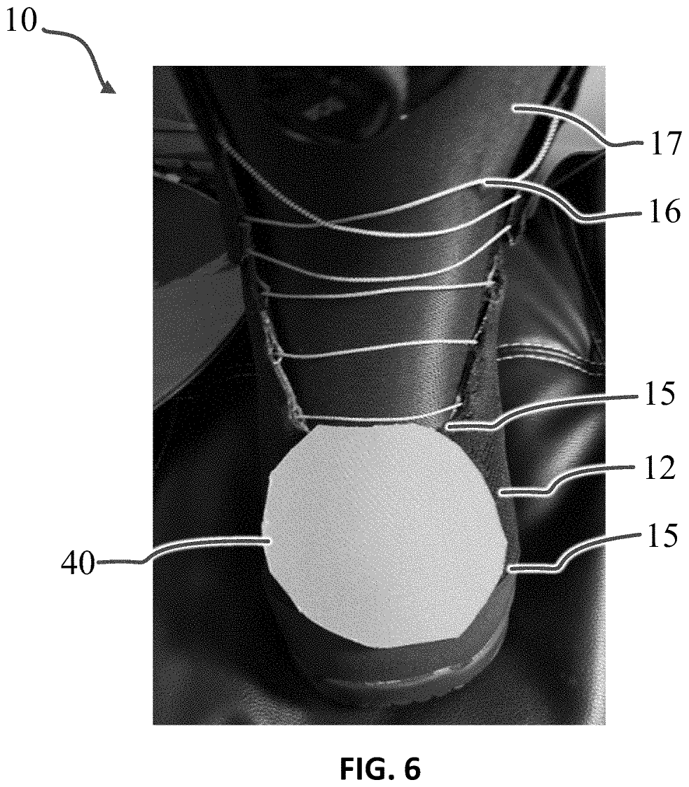

FIG. 6 illustrates a snowboarding boot 10 with an example patch 40 fit onto the snowboarding boot 10 in accordance with some embodiments discussed herein. The patch 40 may be positioned on the front portion 12 of the snowboarding boot 10. In this way, wear on the snowboarding boot 10 caused by a snowboard 20 or the edge 22 of a snowboard 20 on the front portion 12 of the snowboarding boot 10 may be avoided or reduced. Additionally, the patch 40 covers portions of the stitching 15 on the front portion 12 that are particularly at risk of accelerated wear. Instead of acting on the front portion 12 of the snowboarding boot 10 or acting on the stitching 15, cutting action or friction caused by a snowboard 20 acts on the patch 40. In some embodiments, the patch 40 may provide increased resistance to wear from such forces. By including the patch 40, the front portion 12 of snowboarding boot 10 and stitching of the snowboarding boot 10 can be protected from repetitive contact and accelerated wear, such as caused by contact with the edge 22 of a snowboard 20. The cut-resistant material within the patch 40 may accordingly protect the patch 40 from accelerated wear.

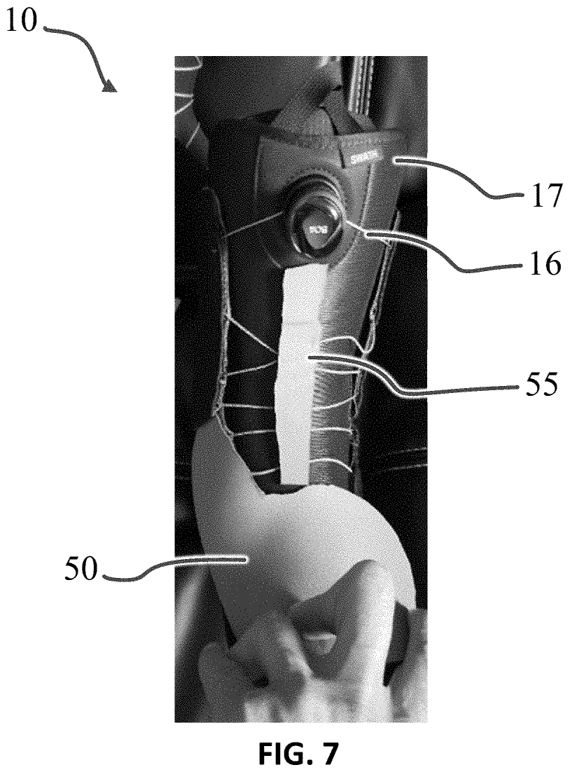

FIG. 7 illustrates a snowboarding boot 10 with a first example patch 50 and a second example patch 55 fit onto the snowboarding boot. The first example patch 50, in some embodiments, may have been cut into the illustrated shape, such as from a larger patch (not shown). The first example patch 50 comprises a predominantly circular or oval shape with a portion that protrudes outwardly (to cover side portions of the snowboarding boot). The first example patch 50 may comprise a shape that protects the exterior surface of the snowboarding boot 10 at the front portion 12 of the snowboarding boot 10, the stitching 15 of the snowboarding boot 10, and also at portions extending along the side of the snowboarding boot 10. As exemplified with the first example patch 50, additional material may be added at various locations on the external surface of the snowboarding boot 10 to provide increased resistance to wear at these locations. The first example patch 50 covers an even greater area on the front portion 12 of the snowboarding boot 10, and the first example patch 50 also provides greater coverage of the stitching 15 at the front portion 12.

In FIG. 7, a second example patch 55 is also included. The second example patch 55 depicted comprises an elongated rectangular shape, but the second example patch 55 may comprise different shapes in other embodiments. By including the second example patch 55, the laces 16 and/or the lip 17 of the snowboarding boot 10 can be protected from accelerated wear caused by contact with the edge 22 of a snowboard 20. The second example patch 55 may be attached to the laces 16 or the lip 17 of the snowboarding boot 10 in a variety of ways. For example, the second example patch 55 may adhere to or otherwise be connected to hollow tubes, and these hollow tubes may define small recesses where the laces 16 may be received. In some embodiments, the second example patch 55 may comprise an adhesive material at only a few select areas, and in other embodiments, no adhesive material may be used. The shape of the second example patch 55 may vary in other embodiments where it is included. By using a second example patch 55 with cut-resistant material, the second example patch 55 may protect the laces 16 and the lip 17 from repetitive contact, and the cut-resistant material within the second example patch 55 may protect the second example patch 55 from accelerated wear.

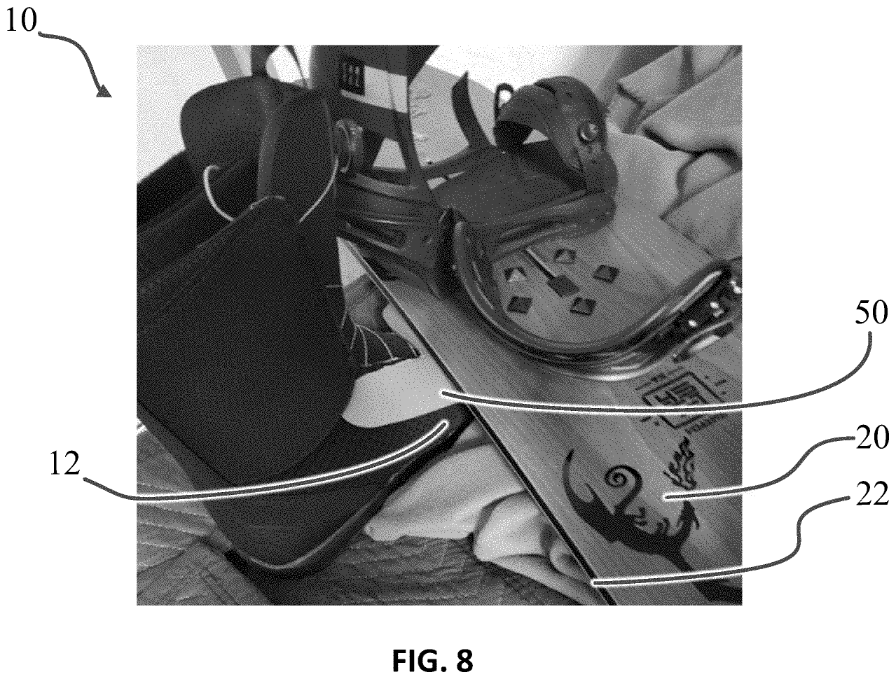

FIG. 8 illustrates a side view of a snowboarding boot 10 with a first example patch 50 fit onto the snowboarding boot 10 and a snowboard 20 resting on the first example patch 50. FIG. 8 demonstrates how a snowboard 20 might rest on a snowboarding boot 10 when a user is riding on a lift. As shown, the edge 22 of a snowboard 20 rests on the cut-resistant first example patch 50. Thus, any friction or cutting action by the snowboard 20 will act on the first example patch 50 rather than the front portion 12 of the snowboarding boot 10. This is beneficial because the first example patch 50 is configured to resist such forces and is less prone to wear over time. The patch 40 (shown in FIG. 4) may act similarly to provide resistance to cutting action or friction on the front portion 12 of the snowboarding boot 10. By incorporating the patch 40 or the first example patch 50, the snowboarding boot 10 may be used for a longer period of time.

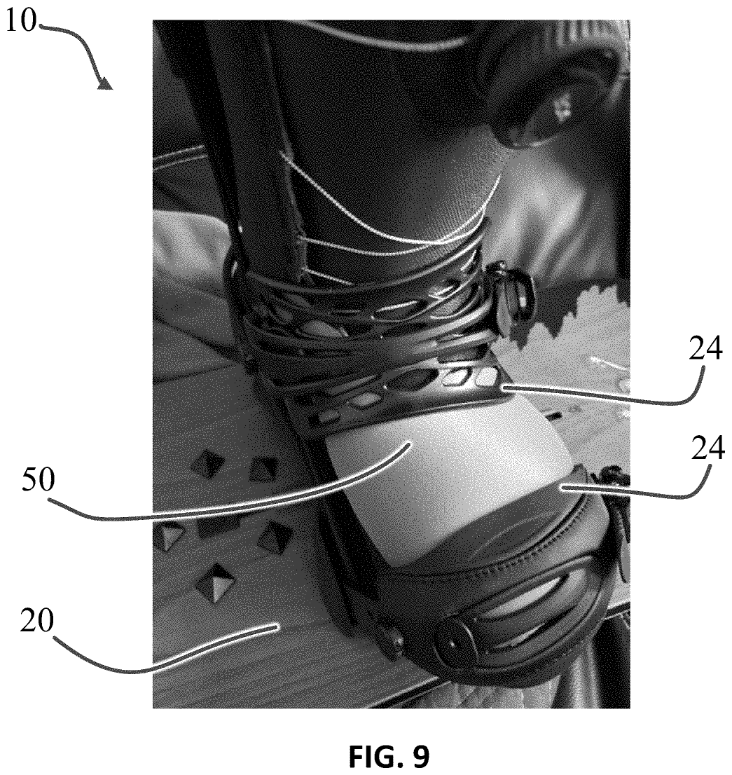

FIG. 9 illustrates a snowboarding boot 10 with a first example patch 50 fit onto the snowboarding boot 10 in accordance with some embodiments discussed herein. As depicted in FIG. 9, one or more boot bindings 24 may be used to secure the snowboarding boot 10 to a snowboard 20. As shown, the boot bindings 24 may be easily secured to a snowboarding boot 10 even when a first example patch 50 is secured to the snowboarding boot 10. One or more boot bindings 24 may also be secured to a snowboarding boot 10 even when a patch 40 is secured to the snowboarding boot 10.

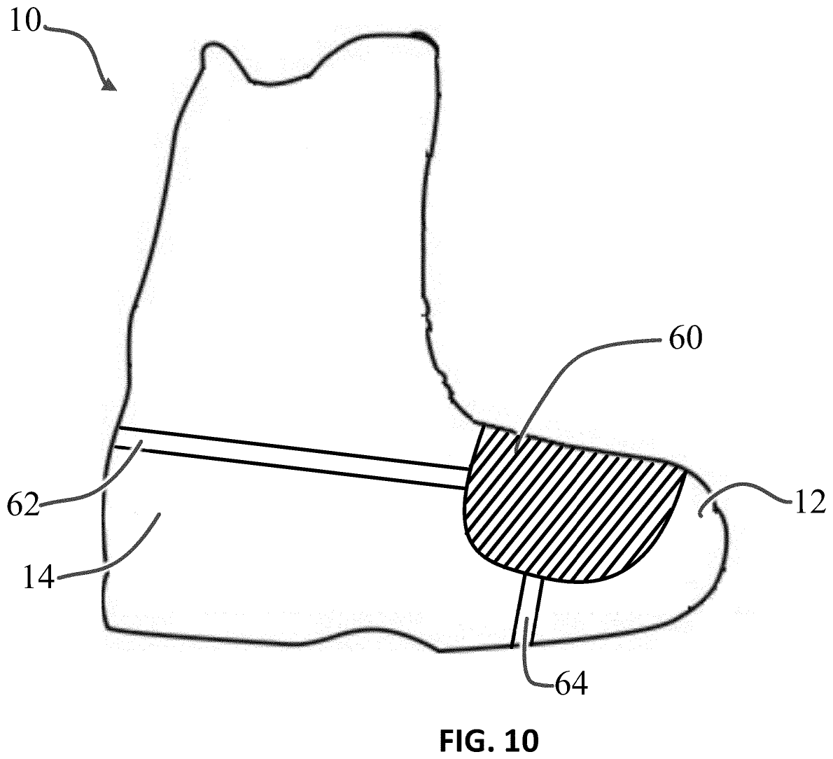

FIG. 10 illustrates a schematic view of a snowboarding boot 10 with a covering 60 in accordance with some embodiments discussed herein (e.g., the covering 60 may be configured in similar fashion to the patch 40). The covering 60 may be positioned on the front portion 12 of the snowboarding boot 10. In FIG. 10, a first strap 62 and a second strap 64 are secured to the covering 60. Each strap may comprise a first end and a second end, and the first end may be secured to a first position of the covering 60 while the second end may be secured to a second position of the covering 60. In this way, a strap and covering 60 may define a hole through which a portion of the snowboarding boot 10 may be received. The first strap 62 is adapted to extend around a back portion 14 of the snowboarding boot 10 that surrounds a heel of the foot contained therein. In FIG. 10, a second strap 64 is included that is adapted to extend around a front portion 12 of the snowboarding boot 10 that surrounds a bridge of the foot contained therein. Only one strap may be attached to the covering 60 in some embodiments, and straps and/or covering 60 may be secured in other positions. In some embodiments, the covering 60 may also comprise additional components to secure the covering in place, such as one or more additional straps, adhesive material, fasteners, etc.

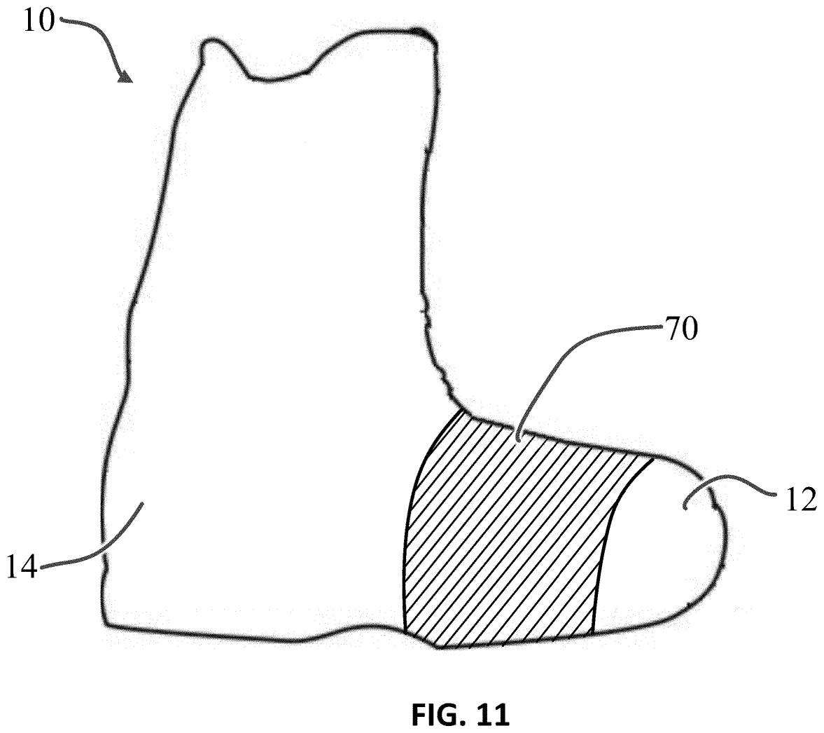

FIG. 11 illustrates a schematic view of a snowboarding boot 10 with a tubular covering 70 in accordance with some embodiments discussed herein (e.g., the tubular covering 70 may be configured in similar fashion to the patch 40). In FIG. 11, a snowboarding boot 10 is shown, and a tubular covering 70 may be positioned on the front portion 12 of the snowboarding boot 10 (e.g., the tubular covering 70 may be stretchable to enable slipping over the front portion 12 of the snowboarding boot 10). However, the tubular covering 70 may be positioned on other portions of snowboarding boot 10. For example, a single tubular covering 70 may be configured to have a size and shape that will envelop the front portion 12, the back portion 14, and the lip 17 (see FIG. 1) of the snowboarding boot 10.

The tubular covering 70 comprises a tubular shape and also defines a hole through which the front portion of the snowboarding boot 10 or some other portion of the snowboarding boot 10 may be received. This tubular covering 70 may be adapted to be fit over the front portion 12 of the snowboarding boot 10 and to surround the front portion. Tubular coverings 70 may be developed in differing sizes to accommodate snowboarding boots of differing sizes, and the size and/or shape of tubular coverings can be modified so that they can be positioned at other locations on snowboarding boots. In some embodiments, the tubular covering 70 may also comprise additional components to secure the tubular covering in place, such as one or more straps, adhesive material, fasteners, etc.

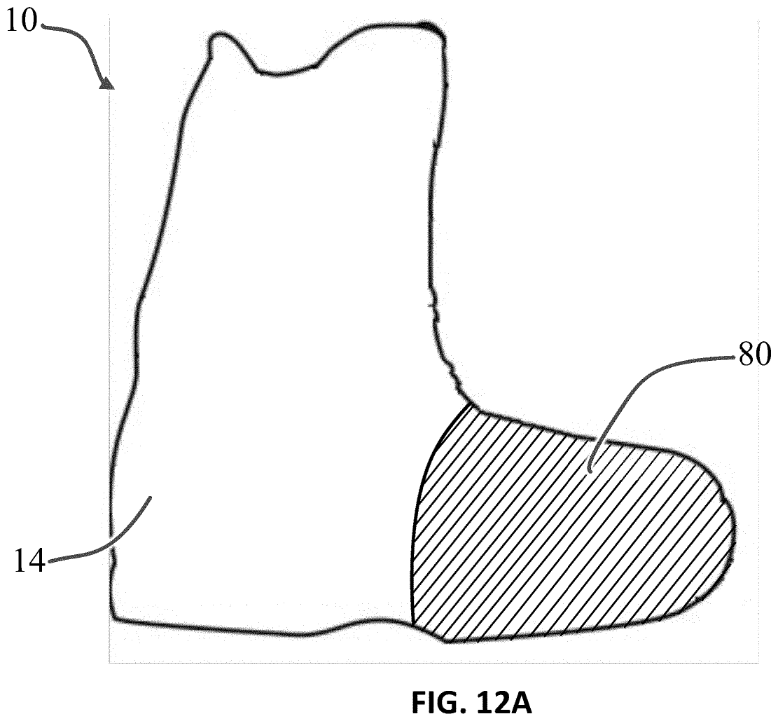

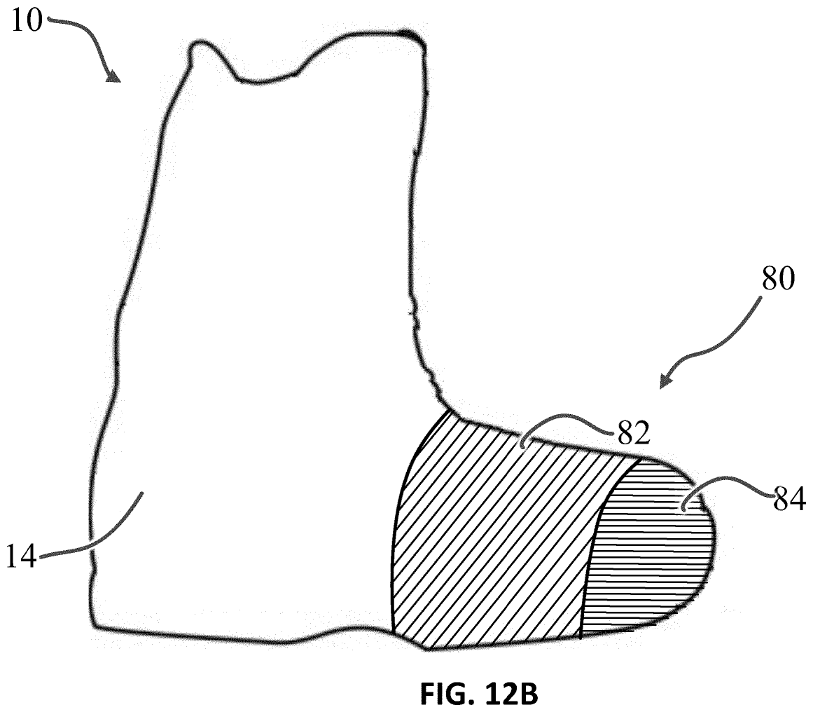

FIGS. 12A and 12B illustrate schematic views of a snowboarding boot 10 with a rounded covering 80, 80′ in accordance with some embodiments discussed herein (e.g., the rounded covering 80, 80′ may be configured in similar fashion to the patch 40). The rounded covering 80 shown in FIG. 12A may be an integral piece and may be positioned on the front portion 12 of the snowboarding boot 10. As shown in FIG. 12B, the illustrated rounded covering 80′ may comprise a first portion 82 and a second portion 84. The first portion 82 has a tubular shape, and this first portion 82 defines a hole through which the front portion 12 of the snowboarding boot 10 or some other portion of the snowboarding boot 10 may be received. The second portion 84 forms a rounded cap at one end of the second portion 84 and the other end of the second portion 84 is connected to the first portion 82 of the rounded covering 80. The first portion 82 and the second portion 84 are adapted to be fit over the front portion 12 of the snowboarding boot 10 and surround the front portion 12. The rounded covering 80, 80′ may be stretchable and/or developed in differing sizes to accommodate snowboarding boots of differing sizes. In some embodiments, the rounded covering 80, 80′ may also comprise additional components to secure the rounded covering in place, such as one or more additional straps, adhesive material, fasteners, etc. The rounded covering 80, 80′ may be positioned at different locations on the snowboarding boot 10. In a further embodiment, a single tubular covering 80, 80′ may be configured to have a size and shape that will envelop the front portion 12, the back portion 14, and the lip 17 of the snowboarding boot 10.

Any covering, including but not limited to the covering 60, the tubular covering 70, and the rounded covering 80, 80′, may comprise cut-resistant material. For example, a covering may be made of rubber composites, Kevlar, nylon, fiberglass, polyethylene fiber, or steel. However, other cut-resistant material may also be used. In some embodiments, a blend of these materials or other materials may be used to form a cut-resistant covering. The cut-resistant material is configured to protect the snowboarding boot 10 from wear or cuts caused by a snowboard 20 being positioned thereon. Coverings may be adapted to be fit over a front portion 12 of the snowboarding boot 10 that surrounds a bridge of a foot contained therein. Coverings may include at least one layer of cut-resistant material positioned along the shape. When a covering is fit over the front portion 12 of the snowboarding boot 10, the cut-resistant material is presented outwardly from the snowboarding boot 10.

Coverings, including but not limited to the covering 60, the tubular covering 70, and the rounded covering 80, 80′, may be easily removed from a snowboarding boot 10 or added to a snowboarding boot 10. Thus, users may optionally leave a covering disposed on a snowboarding boot 10, or users may alternatively don and doff the covering at their convenience. Coverings may also be placed at the tongue 17 and the laces 16 of the snowboarding boot. In some embodiments, a channeled tongue may be provided. In this channeled tongue, protective material may form loops through which the laces 16 may be inserted, and this protective material may protect the laces 16 from wear. The protective material may be secured to the tongue 17 of a snowboarding boot 10 at a first position and at a second position, and a recess may be defined between the tongue 17 and the protective material between the first and second positions. By securing the protective material in this manner, laces 16 may be received through the recess, and the protective material may protect the laces 16 from wear while also allowing the laces 16 to be easily adjusted. In some embodiments, the protective material may be utilized to help secure a patch or covering over the tongue 17 and laces 16. For example, an external face of the protective material may comprise Velcro material, buttons, or other fasteners, and a patch or covering may comprise a similar fastener to allow the patch or covering to be secured over the tongue 17 and laces 16. In some embodiments, patches or coverings may be easily removed from and secured to the protective material.

The coverings and the patches described herein are susceptible of broad utility and application. While the embodiments discussed above each related to coverings and patches to be used with a snowboarding boot, these coverings and patches could also be used with other types of boots such as skiing boots or working boots.

Additionally, the coverings and patches could be integrated into a snowboarding boot during the initial fabrication of the snowboarding boot. Cut resistant material may be used on the entire external surface of the snowboarding boot 10, or a greater amount of cut resistant material may be integrated at locations that are more susceptible to wear (e.g. the front portion 12 of snowboarding boot 10). This cut-resistant material may be provided on only one snowboarding boot, but the cut-resistant material may also be implemented into both snowboarding boots. Cut resistant material may be added as an additional layer at the external surface of the snowboarding boot, the cut resistant material may be integrated or blended with other material to form an external surface of the snowboarding boot, or the cut resistant material may be implemented in other ways.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

1. A cut-resistant patch for application onto a snowboarding boot, the patch comprising:
a first layer of cut-resistant material; and
a second layer of adhesive material positioned below the first layer of cut-resistant material;
wherein the adhesive material is configured to adhere to the snowboarding boot so as to present the cut-resistant material outwardly from the snowboarding boot, and wherein the cut-resistant material is configured to protect the snowboarding boot from wear or cuts caused by a snowboard being positioned thereon.

2. The cut-resistant patch of claim 1, wherein the first layer has a top face and a bottom face, wherein the second layer has a top face and a bottom face, wherein the top face of the second layer is adjacent to the bottom face of the first layer.

3. The cut-resistant patch of claim 2, wherein the top face of the second layer is affixed to the bottom face of the first layer.

4. The cut-resistant patch of claim 1, further comprising a removable third layer positioned below the second layer of adhesive material, wherein removal of the third layer reveals access to the second layer of adhesive material to enable adhering of the patch to the snowboarding boot.

5. The cut-resistant patch of claim 1, wherein the first layer of cut-resistant material is comprised of at least one of a rubber composite, Kevlar, or nylon.

6. The cut-resistant patch of claim 1, wherein the second layer of adhesive material is comprised of at least one of a permanent fabric glue, liquid silicone adhesive, a polyurea adhesive, or a water-based adhesive.

7. The cut-resistant patch of claim 1, wherein each of the first layer and the second layer are configured to be flexible so that the patch can adapt to various shapes of snowboarding boots.

8. The cut-resistant patch of claim 1, wherein an initial size of the patch is such that it covers a front portion of the snowboarding boot, wherein the front portion of the snowboarding boot surrounds a bridge of a foot contained therein.

9. The cut-resistant patch of claim 8, wherein both the first layer and the second layer are customizable in size and shape via cutting from a pair of scissors such that a user may cause the patch to form at least one of a desired shape or size.

10. The cut-resistant patch of claim 1, wherein the first layer of cut-resistant material further comprises a printed image, and wherein the printed image is presented outwardly from the snowboarding boot.

11. The cut-resistant patch of claim 1, wherein the second layer of adhesive is configured to be removable from the snowboarding boot by a user.

12. A system comprising:
a snowboarding boot; and
a cut-resistant patch for protecting the snowboarding boot, the patch comprising:
a first layer of cut-resistant material; and
a second layer of adhesive material positioned below the first layer of cut-resistant material;
wherein the adhesive material is configured to adhere to the snowboarding boot so as to present the cut-resistant material outwardly from the snowboarding boot, and wherein the cut-resistant material is configured to protect the snowboarding boot from wear or cuts caused by a snowboard being positioned thereon.

13. The system of claim 12, wherein the first layer has a top face and a bottom face and wherein the second layer has a top face and a bottom face, wherein the top face of the second layer is adjacent to the bottom face of the first layer.

14. The system of claim 13, wherein the top face of the second layer is affixed to the bottom face of the first layer.

15. The system of claim 12, further comprising a removable third layer positioned below the second layer of adhesive material, wherein removal of the third layer reveals access to the second layer of adhesive material to enable adhering of the patch to the snowboarding boot.

16. The system of claim 12, wherein an initial size of the patch is such that it covers a front portion of the snowboarding boot, wherein the front portion of the snowboarding boot surrounds a bridge of a foot contained therein, and wherein both the first layer and the second layer are customizable in size and shape via cutting from a pair of scissors such that a user may cause the patch to form at least one of a desired shape or size.

17. A cut-resistant covering for use with a snowboarding boot, wherein the covering defines a shape adapted to be fit over a front portion of the snowboarding boot that surrounds a bridge of a foot contained therein, wherein the covering comprises:
at least a layer of cut-resistant material positioned along the shape such that the cut-resistant material is presented outwardly from the snowboarding boot when the covering is fit over the front portion of the snowboarding boot, wherein the cut-resistant material is configured to protect the snowboarding boot from wear or cuts caused by a snowboard being positioned thereon.

18. The cut-resistant covering of claim 17, further comprising a strap adapted to extend around a back portion of the snowboarding boot that surrounds a heel of the foot contained therein.

19. The cut-resistant covering of claim 17, wherein the shape defines a tubular shape that is adapted to be fit over the front portion of the snowboarding boot and surround the front portion.

20. The cut-resistant covering of claim 17, wherein the shape defines a first portion and a second portion, wherein the first portion has a tubular shape, wherein the second portion forms a rounded cap at one end of the first portion, wherein the first portion and the second portion are adapted to be fit over the front portion of the snowboarding boot and surround the front portion.
